(19) United States
(12) Patent Application Publication
(10) Pub. No.: US 2019/0030415 A1
(43) Pub. Date: Jan. 31, 2019

(54) Motion sensor volume control for entertainment devices

(71) Applicant: Joseph Charles Volpe, JR., Malvern, PA (US)

(72) Inventor: Joseph Charles Volpe, JR., Malvern, PA (US)

(21) Appl. No.: 15/731,094

(22) Filed: Apr. 18, 2017

Related U.S. Application Data
(60) Provisional application No. 62/391,751, filed on May 11, 2016.

(51) Int. Cl. A63B 71/06; G06F 3/16; A63B 24/00

(52) U.S. Cl. CPC A63B 71/0622; G06F 3/165; A63B 24/0062; A63B 71/0686; G01C 22/006; A63B 2208/03; A63B 2220/803; A63B 2220/17; A63B 2071/0625

(57) ABSTRACT

Described is a motivational fitness process using motion sensing apparatus to correlate exercise performance with entertainment audio volume for the purpose of rewarding exercise performance goals and penalizing poor exercise performance. The user must exercise in a chosen target training range to maintain a desired entertainment audio volume. Motion sensors in a mobile or stationary device or worn by user provide continuous movement data to a processor unit. The processor receives and compares the user's movement data to a user-specified target range and periodically sends control commands (or not) to raise or lower audio volume output of an entertainment device. If the user's exercise pace drops below a targeted performance range, audio volume output of their entertainment device gradually decreases unless the user reacquires their performance target range at which time volume is restored. Desired volume is maintained so long as target zone performance is maintained.

### BACKGROUND OF THE INVENTION

While the benefits of exercise are well known, it is often the case that one lacks the motivation to exercise regularly and at optimal intensity. Many attempts have been made to develop devices or methods which motivate a person to acquire chosen exercise goals. The prior art holds various examples of exercise intensity sensing devices connected to electronic devices such as running shoes which wirelessly relay motion sensing impact data to fitness applications found on mobile phones.

Other examples found in the prior art are devices and methods which motivate exercise by the changing of tempo or the selection of pre-programmed musical programs or by providing pre-recorded voice messages or audio notifications in the form of beeps or alarms.

The present invention is unique in that it employs the user's desired audio entertainment content as a motivator instead of the various aforementioned pre-programmed audio signals. It uniquely employs motion sensors to utilize the “Premack Psychology Principal” whereby more probable behaviors will reinforce less probable behaviors (Otherwise known as “Grandma's rule,” “How can you have any pudding if you haven't eaten your meat?”)

U.S. Pat. No. 7,354,380 B2 describes a simple motivational method by correlating exercise intensity and audio volume playback. It teaches the use of a heart monitor to control entertainment volume whereby the user must maintain a target heart rate range in order to maintain their desired listening volume.

U.S. Pat. No. 6,572,511 describes a motivational method employing a dedicated portable radio frequency remote control to alter the audio volume and power conditions of televisions based upon heart rate sensor readings.

U.S. Pat. No. 8,033,959 B2 broadly describes mobile phone audio performance feedback but does not describe the process of the volume control of a user's desired audio program based upon target zone performance as described in this application.

U.S. Pat. No. 9,235,203 describes a motivational method whereby mobile phone motion sensors may trigger a succession of audible sounds deemed to be motivational but does not employ the simple method of volume control of the user's desired audio content.

### BRIEF SUMMARY OF THE INVENTION

Example or Practical Use

The user walks or runs while listening to audio entertainment on their mobile phone or other media player. They choose a target training zone representing exercise intensity levels anywhere from a slow walking pace to a sprint. The processor evaluates the motion sensor data and estimates the pace as “steps per minute.” This pace is compared to a target zone range and volume commands are timed at regular intervals. On-target performance is rewarded with desired volume level. Poor performance is penalized by the gradual lowering of volume. Documentation of usage and performance are automatically stored on the device and optionally uploaded to a web-based portal far supervisory review.

Note: An embodiment of this invention was published by this inventor on the Apple App Store on Jan. 4, 2017. Pump Up The Volume Pedometer™.

### BRIEF DESCRIPTION OF THE DRAWINGS

FIG. 1 illustrates the present embodiment of this process for motivating target zone training exercise utilizing the motion sensors of a mobile phone to control audio volume.

FIG. 2 is a flow chart of the logic used by the microprocessor of FIG. 1

FIG. 3 shows sample mobile phone application screenshots of the present embodiment.

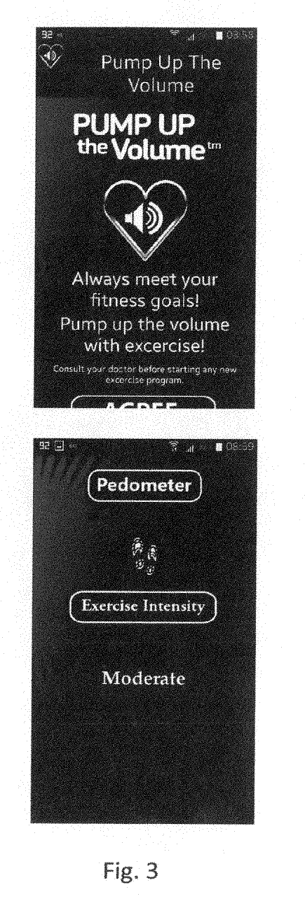

FIG. 4 shows a screenshot of present embodiment showing user-selectable target zones.

FIG. 5: shows screenshots of a “volume down” indicator (because 36 steps per minute is below the chosen target of 81-140 steps per minute, and a “Back in Target Zone” indicator.

FIG. 6 shows various examples of fitness equipment that may employ this process.

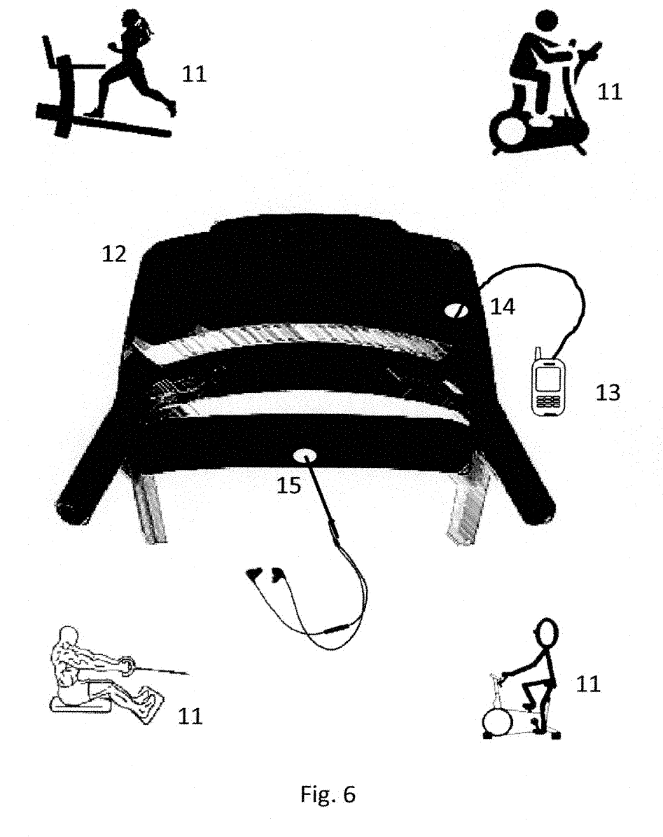

FIG. 7 shows a swimmer using a personal audio device that may employ this process.

### DETAILED DESCRIPTION OF THE INVENTION

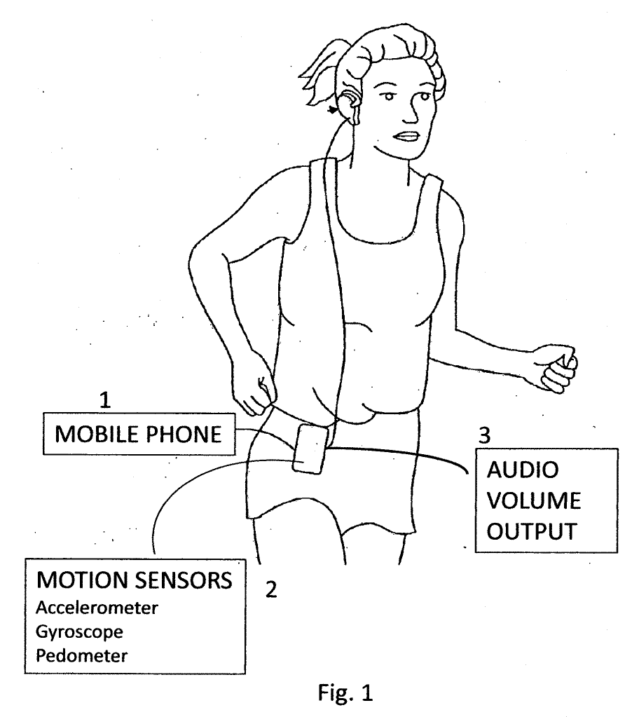

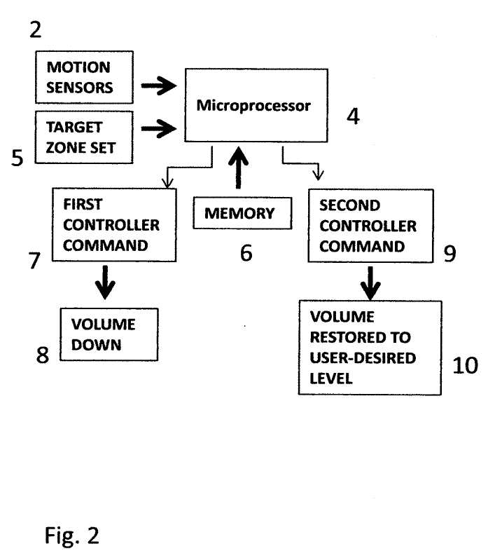

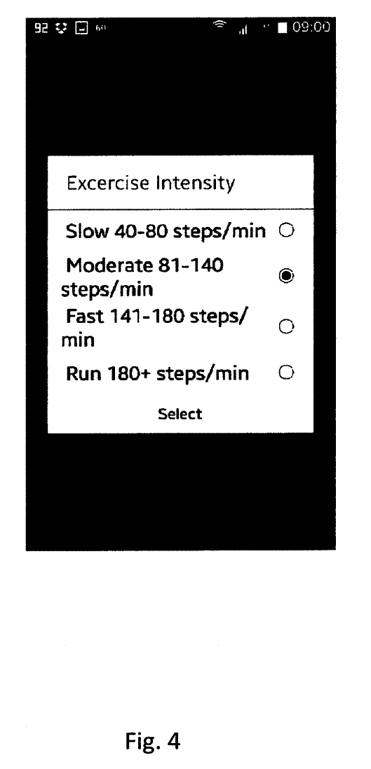

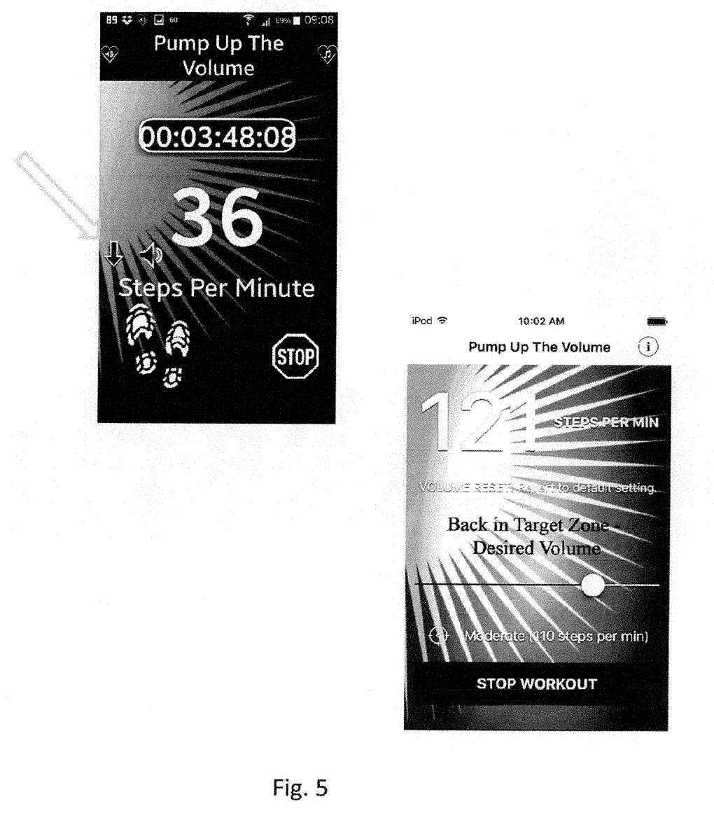

The present embodiment is shown in FIG. 1. The User Plays audio entertainment from their mobile device and manually sets output volume to a comfortable listening level using the device's hardware buttons or with an interactive touch-screen graphical interface. This volume level is memorized 6 by the microprocessor 4 shown in FIG. 2. The User also selects a desired exercise target training zone 5 represented as a range of “Steps per Minute.” The User proceeds to walk or run on ground or an exercise machine. The user's steps are sensed by the mobile phones' internal motion sensors 2 and are then interpreted by the mobile phone's microprocessor 4. The microprocessor 4 employs an algorithm to estimate the user's pace and functions as a pedometer reading displayed on screen as “steps-per minute.” At regular timed intervals the actual pace is compared with the desired target zone range 5 and based on that comparison the microprocessor 4 sends volume control commands for volume down 8, or, volume restoration to user's desired level 10 or no command at all. The processor 4 interprets the motion sensor 2 data and If the user's pace falls below the target threshold the audio volume level is gradually reduced. FIG. 5 is a screenshot of the current embodiment showing that the user's pace at 36 steps-per-minute has fallen below the chosen target zone threshold of 81 steps-per-minute shown in FIG. 4. The amount of volume change is of a degree that is clearly obvious to the user and the display shows that a volume-down command 8 is being sent. If the user fails to reacquire the target zone before the next timed interval, another volume-down 8 command is sent. Successive volume-down commands 8 continue, reducing the volume level to zero until the user re-acquires their desired target zone. Volume is immediately restored 10 to the user's preference as stored in memory 6 when the user's pace returns to the target zone. The user may simply turn off the process at any time and continue to enjoy their audio program without interruption.

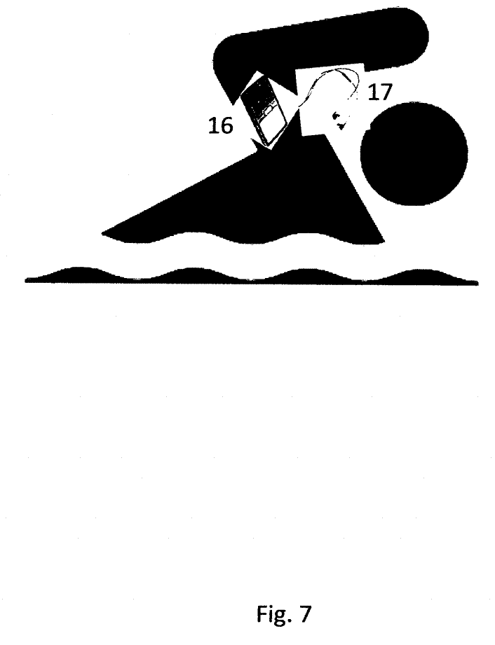

The processor 4 stores a record of each session the process is employed. The record of each session contains the date, time and duration of the exercise performed. The record may be viewed on the device or electronically transmitted via email or uploaded to a network portal. Although the embodiment described above is specific for purposes of illustration, other permutations of the motion sensor control of audio volume for the purpose of motivating exercise with audio entertainment are possible within the spirit and scope of the invention. For example, this method may be employed in a dedicated media player device or “smartwatch” instead of a mobile phone. Exercise machines of various types 11 may mediate the volume of the user's personal media player via standard wireless or wired interface connections. A rowing machine may have motion sensors and a target training zone based upon strokes-per-minute instead of steps-per-minute. An exercise bicycle may utilize revolutions-per-minute data. The control console 12 on an electronic fitness machine may house the microprocessor 4 and provide an interface 14 to receive audio signals from an external audio source 13 such as a mobile phone or media player. The volume down 8 and volume restore 10 commands would control the audio output interface 15 to a sound producing device such as earphones 17 or external speakers. A swimmer FIG. 7 may wear a waterproof music player 16 containing a motion sensor on their arm with target zones based upon strokes-per-minute, etc. Wired earbuds 17 may be supplanted with wireless audio devices or remote speakers. Alternative methods for defining the target zone may also be employed. For example: instead of the user choosing a pre-defined target zone, a specific target number and degree of variation may be chosen. For example: 110 steps per minute plus or minus 20 steps.

1. A method for motivating a person doing fitness exercise comprising the steps of:
providing an entertainment device having a power supply, at least an audio output operable to be set at a given stored output which is a comfortable listening level, audio entertainment content, and a processor, a controller for modulating audio output and motion sensors; generating commands directed to said controller, monitoring the rate of a repetitive motion of the person, comparing said repetitive motion pace with a target range of data, and causing said commands to be indicative of the variation of said repetitive motion pace relative to said target range and using said generated commands to raise or lower the audio volume.

2. A method according to claim 1 wherein the person exercising pre-selects audio entertainment content.

3. A method according to claim 1 wherein said commands decrease the volume of said audio output when the said repetitive motion pace falls below said target range wherein the degree of volume change for each said volume-down command is great enough to be clearly perceived by the user yet small enough to provide time opportunity for the user to re-acquire said target zone and desired volume without interruption of audio entertainment.

4. A method according to claim 1 wherein said monitoring and generating steps produce commands to said controller which modulate the audio volume wherein the duration of the time interval between said commands is small enough to provide continual audio volume feedback yet long enough to provide time opportunity for the user to re-acquire said target zone and desired volume without interruption of audio entertainment.

5. A method according to claim 1 wherein said command restores or maintains the said comfortable listening volume of the audio output when the said repetitive motion pace falls within said target range.
